(19) United States
(12) Patent Application Publication
(10) Pub. No.: US 2022/0188769 A1
(43) Pub. Date: Jun. 16, 2022

(54) TERMINAL SITE OPTIMIZATION TOOL

(71) Applicant: R & L Carriers, Inc., Wilmington, OH (US)

(72) Inventor: Ronald F. Galason, New Lenox, IL (US)

(73) Assignee: R & L Carriers, Inc., Wilmington, OH (US)

(21) Appl. No.: 17/122,454

(22) Filed: Dec. 15, 2020

(51) Int. Cl. G06Q 10/08

(52) U.S. Cl. CPC G06Q 10/08345; G06Q 10/0838

(57) ABSTRACT

Systems, methods, and media of terminal site optimization are provided. A method includes receiving input specifying a current terminal. The method also includes receiving input specifying one or more potential terminal relocation sites. The method further includes analyzing costs of a relocation site based upon shipping costs on a per-service area basis. The costs of a relocation site are also analyzed based upon pickup costing and delivery costing on a per-service area basis. The costs of a relocation site are additionally analyzed based upon adjusted costs for the current terminal. The method additionally includes outputting current and change-site costing data.

### TECHNICAL FIELD

Embodiments described herein generally relate to systems and methods of dynamically planning carrier terminal placements and more particularly, to systems and methods for analyzing the effects of structural changes in the form of openings, closings, and/or reconfiguring terminal placement.

### GENERAL BACKGROUND

The shipping industry consists primarily of three types of carriers, each offering services that satisfy different customer needs. There are small package carriers like Federal Express, United Parcel Service and others who pick up small packages, consolidate these packages into large loads, move them close to their destination point and then deliver the packages. At the opposite end of the shipping business are the large customers which fill entire trucks or trailer loads and are considered to be truck load shippers. The category in between the truck load shippers and the small package shippers are less-than-a-load (LTL) carriers. Similar to the UPS driver who collects and delivers many small packages during a business day, the less-than-a-load (LTL) carrier picks up freight from upwards of 20 different customers. This freight is typically destined to many different locations around the country. The freight is brought back to a terminal where the shipments are unloaded from the truck, consolidated with other freight moving in the same direction and then reloaded on delivery trucks. The freight is sorted and consolidated into truck loads at the terminal to minimize the empty space on the truck that will transport the freight from the local terminal to either a local delivery or a distribution terminal in another city or state. The truck will be unloaded at the distribution terminal and its freight restored and reconsolidated for delivery to customers in the local area around the distribution terminal or shipment to another distribution terminal.

Carriers utilize distribution terminals (or hereinafter terminals) as a central part of their operations. As customer needs, routes, and shipping trends change, a carrier may change their distribution terminal configuration. This may involve opening, closing, and/or reconfiguring distribution terminals. However, many factors go into making such structural changes, such as the efficiency of resource utilization. For example, each individual shipment is governed by a separate contract called a “bill of lading”. Often, customers will have their own bill of lading form that they use for shipping. Thus, over the course of a day a truck driver may collect many different bill of lading forms, one for each shipment. As in any business, efficiency and speed are measuring sticks for customer service. As an internal matter, as with any other business, the faster payment is received, the better the cash flow. The speed and efficiency of these processes are what gives a trucking or other carrier a competitive edge. Typically, a truck driver will leave the truck terminal in the morning and return in the evening. The driver returns with a hand full of bill of lading forms and other paper work which is submitted to the corporate office where it is processed by billing clerks using data entry skills. After the information from each bill of lading is entered, the shipping information is transmitted to the loading dock at the terminal so that the freight moving to common points can be consolidated and the delivery schedule planned.

The goal of proper load planning is to deliver the freight on time with the delivery truck leaving the terminal with a full load. Unfortunately, both the truck used to pick up the freight and the truck used to deliver the freight are often sitting idle at the terminal while the data entry and load planning functions are being performed. Additionally, because the freight typically comes in one truck at a time the loading dock may not know in advance of the trucks' arrival at the terminal or the contents and the destination of the freight picked up on a given day. Consequently, a delivery truck will often depart the terminal only partially loaded. Many of these partially loaded trucks could have been fully loaded had the load planner known about unscheduled freight that had been picked up and would soon arrive at the terminal. This movement of freight as partial also results in decreased efficiency, increased costs and reduced profits for the trucking company.

### SUMMARY

In one embodiment, a method of terminal site optimization includes receiving input specifying a current terminal. The method also includes receiving input specifying one or more potential terminal relocation sites. The method further includes analyzing costs of a relocation site based upon shipping costs on a per-service area basis. The costs of a relocation site are also analyzed based upon pickup costing and delivery costing on a per-service area basis. The costs of a relocation site are additionally analyzed based upon adjusted costs for the current terminal. The method additionally includes outputting current and change-site costing data.

In another embodiment, a terminal site optimization system includes memory and a processor coupled to the memory. The system also includes a user interface module configured to receive input specifying a current terminal. The user interface module is also configured to receive input specifying one or more potential terminal relocation sites. The user interface module is further configured to output current and change-site costing data. The system further includes a cost assessment module configured to analyze costs of a relocation site based upon shipping costs on a per-service area basis and pickup costing and delivery costing on a per-service area basis. The cost assessment module is also configured to analyze costs of a relocation site based upon adjusted costs for the current terminal as selected by the user.

In yet another embodiment, a non-transitory computer readable medium embodies terminal site optimization computer-executable instructions, that when executed by a processor, cause the processor to execute operations that include receiving input specifying a current terminal. The medium includes additional instructions for receiving input specifying one or more potential terminal relocation sites. The medium also includes instructions for analyzing costs of a relocation site based upon shipping costs on a per-service area basis and pickup costing and delivery costing on a per-service area basis. The medium also includes instructions for analyzing costs of a relocation site based upon adjusted costs for the current terminal. The medium includes further instructions for outputting current and change-site costing data.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a site configuration tool within a computer interface according to one or more embodiments described and illustrated herein;

FIG. 2A schematically depicts a site design management interface according to one or more embodiments described and illustrated herein;

FIG. 2B1-2B4 schematically depict a site analysis tool interface according to one or more embodiments described and illustrated herein;

FIG. 2C schematically depicts a zipcode change interface within the site analysis tool interface depicted by FIG. 2B according to one or more embodiments described and illustrated herein;

FIG. 2D1-2 schematically an updated site analysis tool optimization interface according to one or more embodiments described and illustrated herein;

FIG. 3 schematically depicts an overall cost report analysis interface according to one or more embodiments described and illustrated herein;

FIG. 4A schematically depicts a zip-code based terminal service area interface according to one or more embodiments described and illustrated herein;

FIG. 4B schematically depicts an inbound/outbound interface as part of the zip-code based terminal service area interface depicted by FIG. 4A according to one or more embodiments described and illustrated herein;

FIG. 5 schematically depicts a freight matrix interface according to one or more embodiments described and illustrated herein;

FIG. 6 is a flow chart depicting an exemplary process of providing cost analysis of a specified relocation site, according to one or more embodiments described and illustrated herein; and

FIG. 7 is a block diagram illustrating hardware utilized in one or more devices for implementing various processes, media, and systems, according one or more embodiments described and illustrated herein.

### DETAILED DESCRIPTION

As customer needs, routes, and shipping trends change, a shipper may change their terminal configuration. This may involve opening, closing, and/or reconfiguring terminals. However, many factors go into making such structural changes. Embodiments of the present disclosure relate to analyzing the effects of changes in distribution center (i.e., terminal) placement. For example, in considering the addition of a new distribution center, the change in cost can be analyzed in a variety of ways, such as the change in shipping cost on a per-zip-code basis. This may be accomplished by going through every zip code and mathematically figure out the best pickup and delivery costing advantage of moving that specific zip code. Costs associated with a distribution center may include pickup charges, delivery charges, linehaul charges, and dock changes may be considered as a quick and easy way to evaluate new potential terminal locations added to a shipper's network and what the overall costing impact will be. This also provides the real-world advantage of giving the shipper the ability to analyze current terminal service areas and review whether zip code alignment changes can be made to save overall cost and fill linehaul capacity.

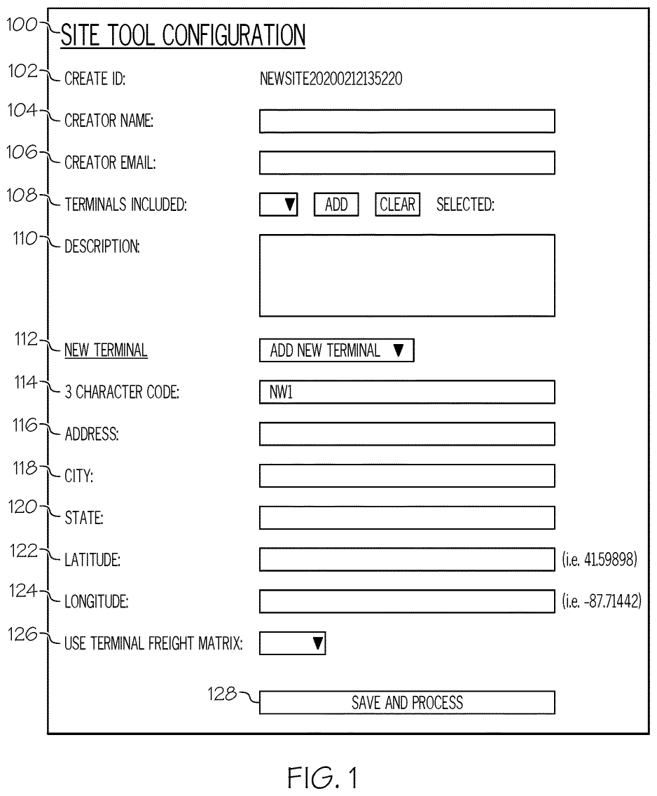

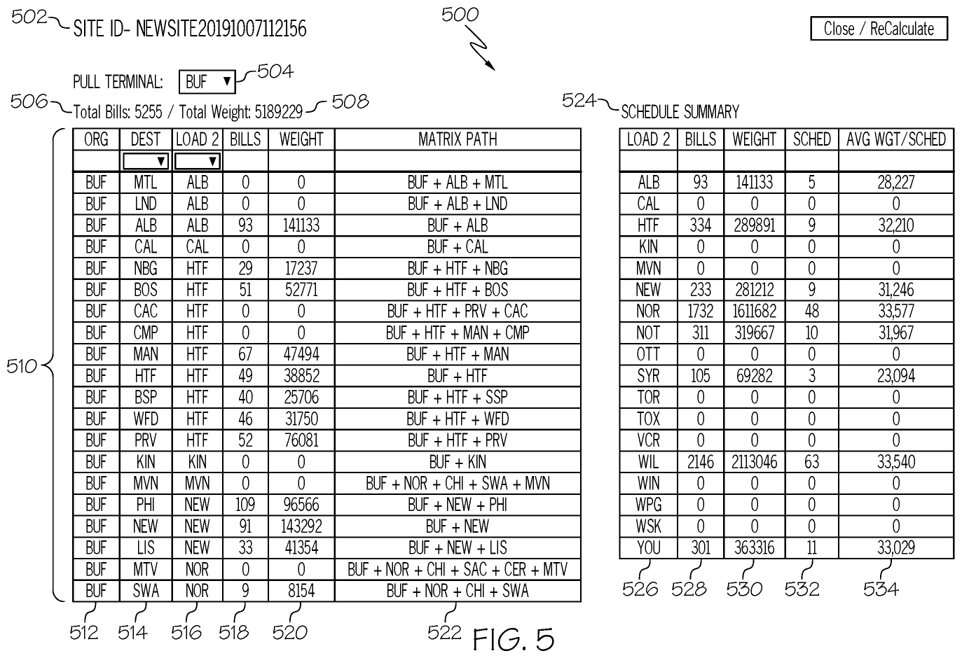

Referring now to FIG. 1, a site configuration tool 100 within a computer interface is depicted. The site configuration tool 100 provides a design configuration ID 102 to uniquely identify a site design (or a terminal site design, as these terms may be used interchangeably herein). As used herein, a site design may refer to a configuration of one or more terminals, including potential new terminal sites and/or relocation of existing terminals. The contact information, such as creator name 104 and/or creator email 106, may be entered, although any suitable contact information may be used (phone, fax, social media username, and the like). The terminals included 108 may be based upon terminals already in the system, in which a user can add, remove, or edit such terminals, or clear all terminals for the site design associated with the design configuration ID 102. A design configuration description 110 field allows for a description to be added to provide context or further explanation or notes regarding the design configuration. An option to add a new terminal 112 may include a terminal character code 114, which may be a three letter in this embodiment, but any suitable identifier may be utilized to uniquely identify a terminal. In some embodiments, there may other selectable options such as modifying an existing terminal or removing a terminal from the same drop-down box (or any other suitable option-selection technique in various embodiments). Location information such as terminal address 116, terminal city 118, terminal state 120, terminal latitude 122, and/or terminal longitude 124 may be used to further define a terminal. A terminal may be selected for use in a freight matrix 126 (as discussed below with respect to FIG. 5). A design save button 128 allows a user to save the design such that it may be associated with the design configuration ID 102.

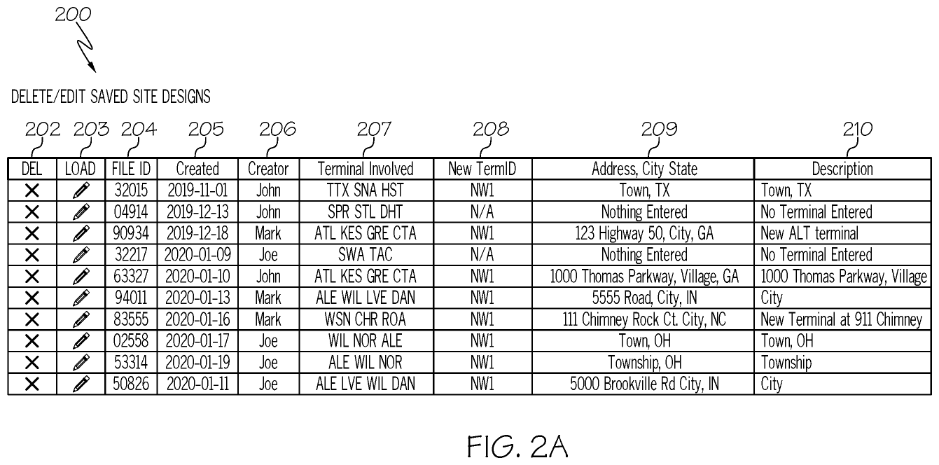

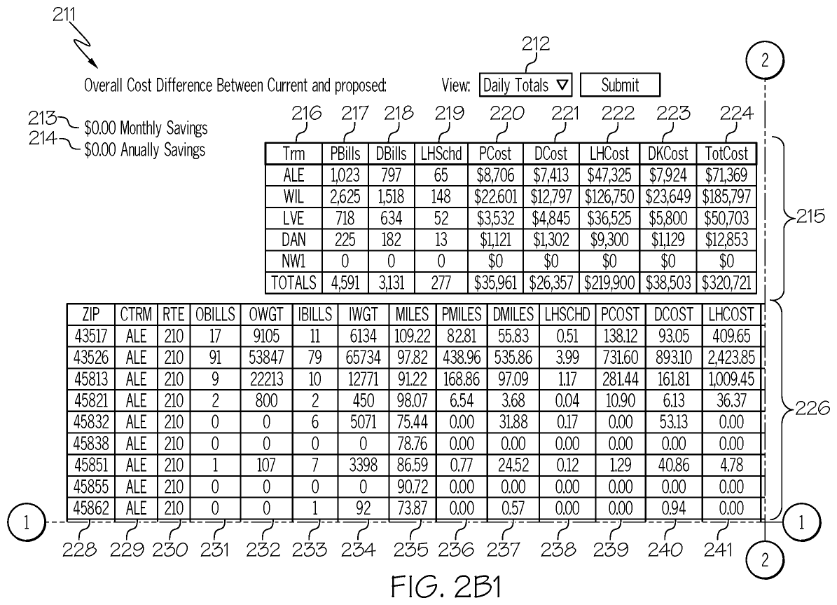

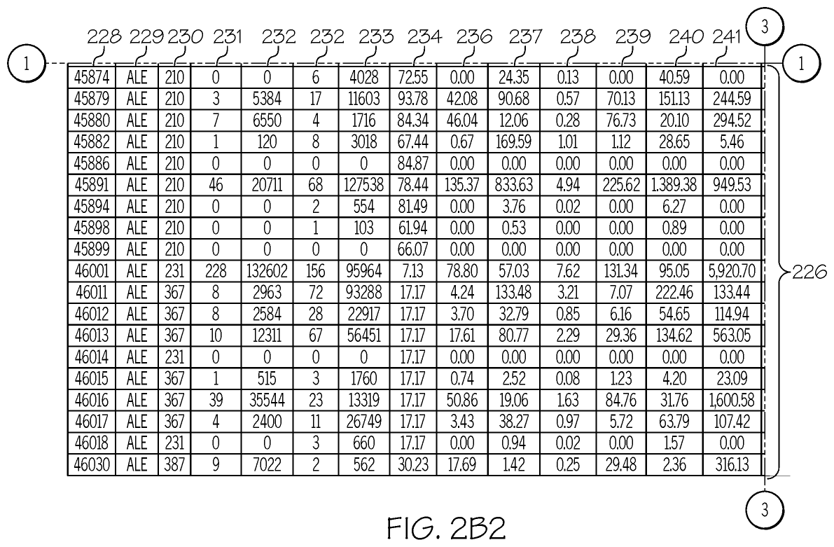

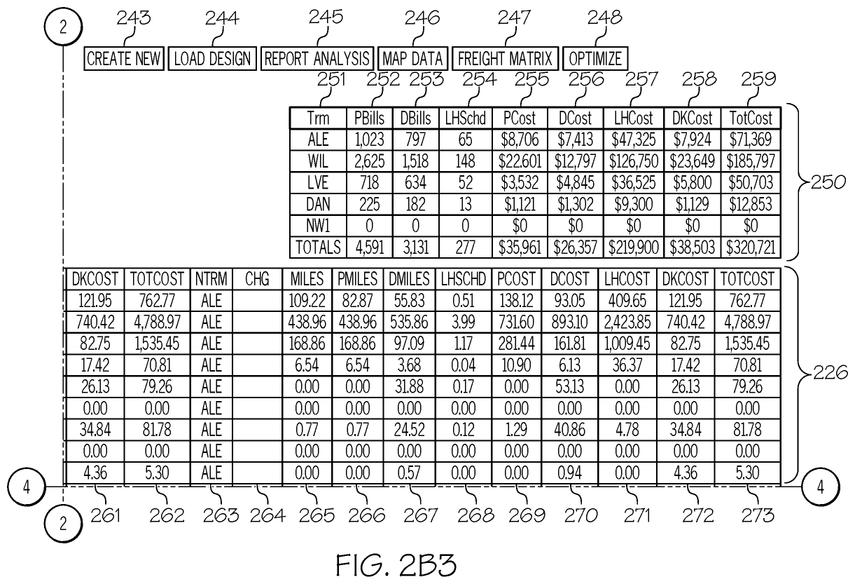

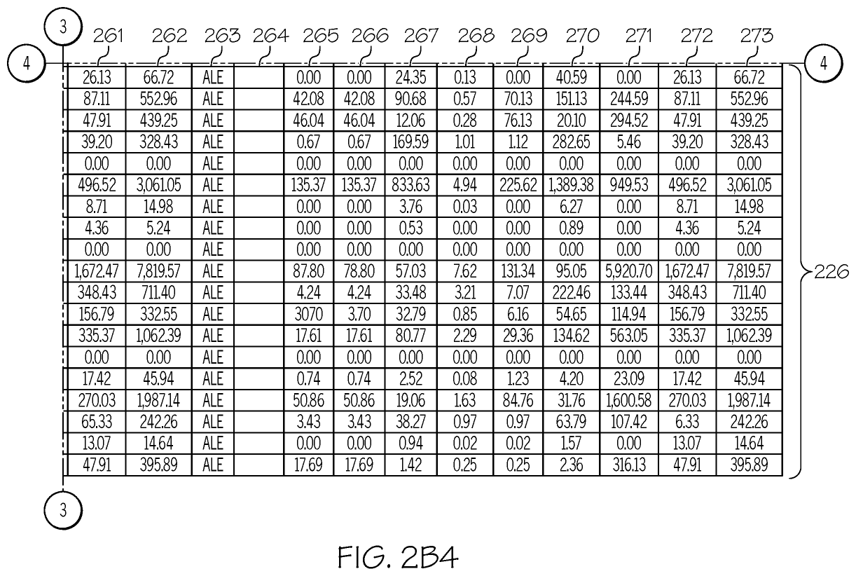

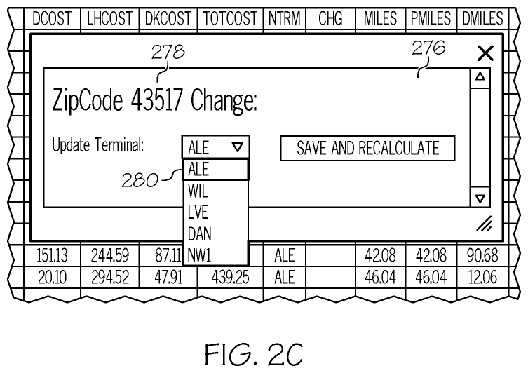

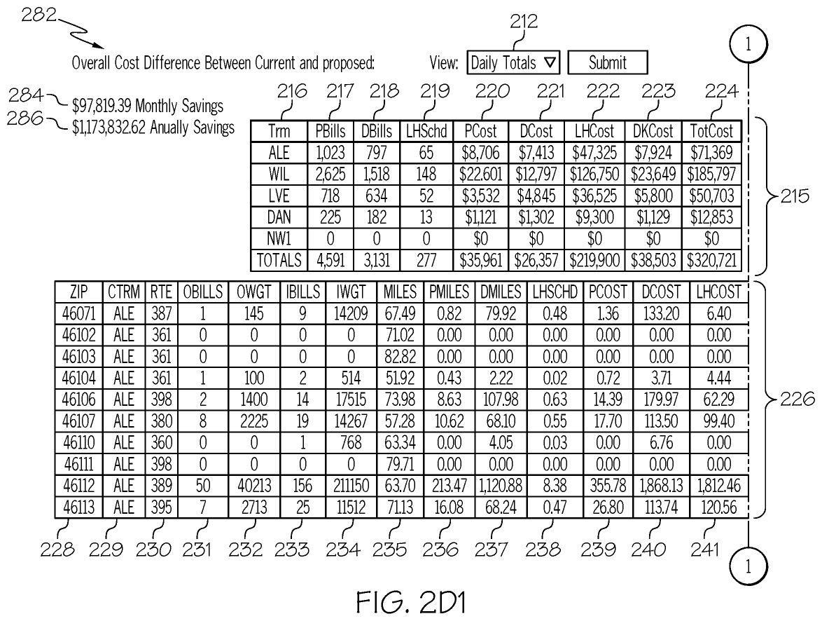

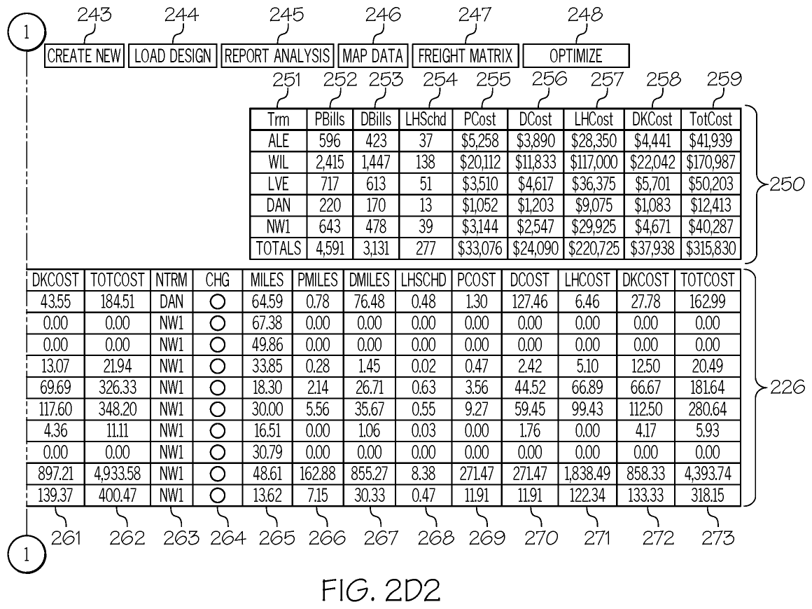

Turning to FIG. 2A, a site design management interface 200 is depicted, in which previously-created site designs can be managed. Options include design deletion 202 and design loading 203, where displayed information may include the design ID 204, the design creation date 205, design creator 206, (which may be a username, the creator's name, or any other suitable identifier). The involved terminal(s) 207 may be displayed by the appropriate identifier(s), such as the three letter identifier(s). The proposed new terminal may be represented by a new terminal ID 208, along with the new terminal address 209 the new terminal description 210, which may correspond to the corresponding fields in FIG. 1.

Turning to FIGS. 2B1-2B4, a site analysis tool interface is depicted. In FIG. 2B1, the loaded design 211 includes design view options 212 such as daily totals (depicted here) as well as any other suitable duration totals such as hourly, weekly, monthly, annually, live (i.e. using live data) and the like. Monthly savings 213, annual savings 214, and/or savings based upon any other suitable duration may be totaled as between a current terminal and a proposed terminal. A table depicting a current site costing view 215 provides a summary view of the current terminal configurations 216 associated with the site design. This includes, for each current terminal configuration 216, the number of current pickup bills 217 (i.e., inbound bills of lading; a bill of lading may herein be referred to as a “bill”) and current delivery bills 218 (i.e., outbound bills of lading). The current linehaul schedule 219 for each current terminal configuration 216 may be determined based upon the total weight of every destination for the current terminal configuration 216, and determining the total weight of each matrix path (522 FIG. 5) for the current terminal configuration 216 based upon the terminal's freight matrix (FIG. 5). The total linehaul lane weight (i.e., a summation of the lane weights, see 530 FIG. 5) may be divided by a utilization limit per truck (34,000 pounds in this embodiment, although any other suitable average may be utilized in other embodiments). Thus, any weight above the utilization limit would require another truck per lane. For example, ALB in LOAD 2 (526 FIG. 5) has a (total) weight (530 FIG. 5) value of 141,133 pounds. Dividing this number by the utilization limit of 34,000 gives an approximate value of 4.15. Since the extra 0.15 cannot be carried by any of the 4 trucks already filled, a fifth truck would be needed, thus giving a line schedule value (532 FIG. 5) of 5 for the lane.

The current pickup cost 220 per current terminal configuration 216 may be based upon the mileage involved multiplied by the capacity of the trailer of the truck, and multiplied by the percentage of weight. The current delivery cost 221 per current terminal configurations 216 may be based upon the mileage involved multiplied by the capacity of the trailer of the truck, and multiplied by the percentage of weight. The current linehaul cost 222 for each current terminal configuration 216 may be determined based upon the current linehaul schedule 219 multiplied by the total distance for the current linehaul schedule 219 multiplied by the linehaul rate of $1.50 per mile in this embodiment (any suitable rate may be utilized in other embodiments). The current dock cost 223 for each current terminal configuration 216 may be determined based upon the number of hours needed to move all the bills (for all the inbound bills and outbound bills) multiplied by a rate (a $25 hourly rate in this non-limiting example). The current total cost 224 for each current terminal configuration 216 may be determined by summing the current pickup cost 220, the current delivery cost 221, the current linehaul cost 222, and the current dock cost 223.

In FIGS. 2B1-2B4, another table depicting a loaded design comparisons view 226 is provided on a per-zip code basis. The current terminal, as discussed in more detail below, is represented by fields that include the current terminal 229, zip code current pickup miles 236, zip code current delivery miles 237, zip code current linehaul schedule 238, zip code current pickup cost 239, zip code current delivery cost 240, zip code current linehaul cost 241, zip code current dock cost 261, and zip code current total cost 262. Fields relating to the new terminal, discussed in more detail below, include the new terminal 263, changed/optimized value 264, zip code new miles 265, zip code new pickup miles 266, zip code new delivery miles 267, zip code new linehaul schedule 268, zip code new pickup cost 269, zip code new delivery cost 270, zip code new linehaul cost 271, zip code now dock cost 272, and zip code new total cost 273.

In FIGS. 2B1-2B2, for each current terminal zip code 228, there may be a current terminal 229 and a zip code associated route 230 (in this non-limiting example ‘210’ corresponds to a cluster of zip codes that make up the 210 route). For each zip code 228 the number of zip code outbound bills 231 and the zip code monthly outbound weight 232 (based on a summation of zip code outbound bills 231) are provided. Additionally, the number of zip code inbound bills 233 and the zip code inbound weight 234 (based on summation of zip code inbound bills 233) may be provided for each zip code 228. The zip code current miles 235 may be based upon the distance between the current terminal 229 and the zip code 228 (e.g., the center of the zip code 228 in this example). The zip code current pickup miles 236 may be based upon the number of zip code outbound bills 231 multiplied by the zip code current miles 235. The number of zip code current delivery miles 237 may be based upon the number of zip code inbound bills 233 multiplied by the zip code current miles 235. The zip code current linehaul schedule 238 may be determined by calculating each zip code's destination total weight what percentage the zip code's weight is attributable to that destination's total lane schedule weight. This percentage may then be used to determine the proportional amount for the zip code current linehaul schedule 238. The zip code current pickup cost 239 may be determined by the total pickup cost associated with the current terminal 229 with respect to the zip code 228 (i.e., the mileage involved multiplied by the capacity of the trailer of the truck, and multiplied by the percentage of weight). In some embodiments, the zip code current pickup cost 239 may be determined by taking the total weight picked up in a specific zip code and dividing that by the average pickup unit weight of 12,000 pounds (any suitable number may be utilized), multiplied by the mileage to that zip code, and then multiplied by a 30 mph average driving speed (any suitable speed value may be utilized), and then multiplied by driver cost per hour at $50.00 per hour (any suitable driver cost and/or time units may be utilized).

The zip code current delivery cost 240 may be determined by the total delivery cost associated with the current terminal 229 with respect to the zip code 228 (i.e., the mileage involved multiplied by the capacity of the trailer of the truck, and multiplied by the percentage of weight). In some embodiments, the zip code current delivery cost 240 may be determined by taking the total weight delivered to a specific zip code and dividing that by the average pickup unit weight of 12,000 pounds (any suitable number may be utilized), multiplied by the mileage to that zip code, and then multiplied by a 30 mph average driving speed (any suitable speed value may be utilized), and then multiplied by driver cost per hour at $50.00 per hour (any suitable driver cost and/or time units may be utilized).

The zip code current linehaul cost 241 may be based upon the destination total weight of the zip code 228 used to determine a percentage of weight to a destination's total lane schedule weight, and multiplying that percentage by the total lane schedules and costs for every destination within the zip code 228. Put another way, the zip code current linehaul cost 241 may be determined by multiplying a calculated percentage of total weight by zip code by a total cost for schedules for that load to a destination point.

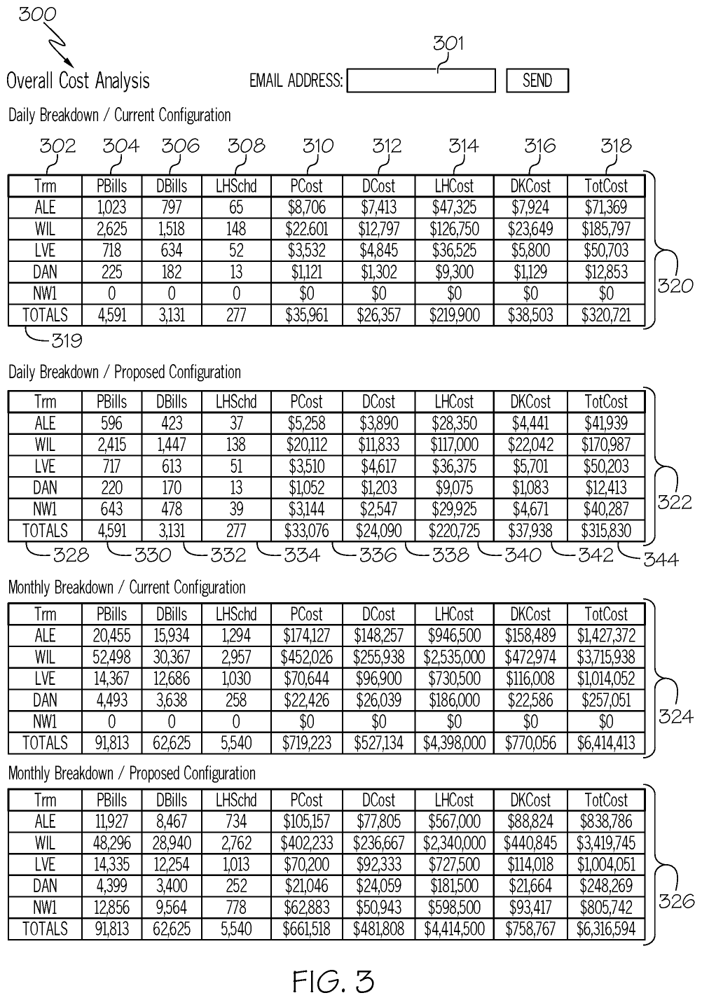

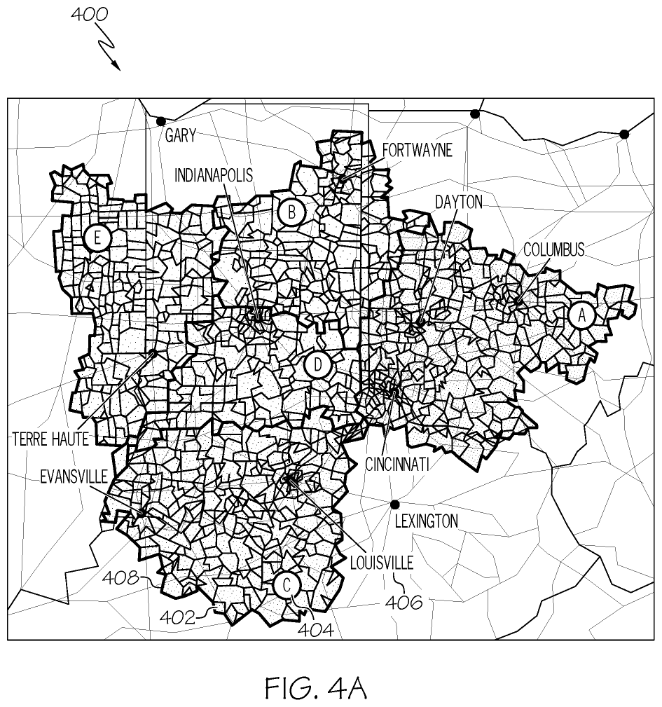

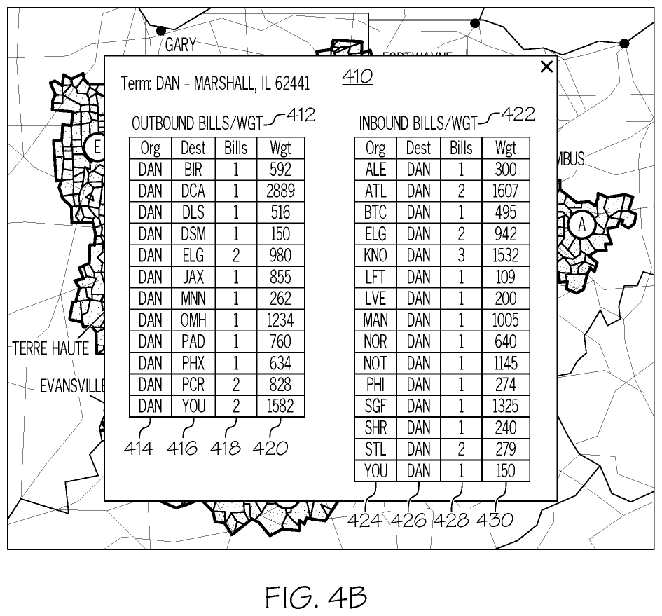

Continuing with the site analysis tool interface depicted in FIGS. 2B1-2B2, additional features are depicted in FIGS. 2B3-2B4. A button interface along the top of FIG. 2B3 may provide selectable options such as, by way of non-limiting example, create new 243 (e.g., setting up new terminals in the configuration interface depicted in FIG. 1), load design 244 (e.g., pulling saved site designs in the site design management interface depicted in FIG. 2A), report analysis 245 (e.g., the overall cost report analysis interface depicted in FIG. 3), map data 246 (e.g., the zip-code based terminal service area interface depicted in FIGS. 4A-4B), freight matrix 247 (e.g., the freight matrix interface depicted in FIG. 5), and optimize 248 (e.g., go through every zip code 228 and determine the best pickup and delivery costing advantage of moving that specific zip code).

A table depicting a new site costing view 250 provides a summary view of the reconfigured terminals 251 associated with the site design. This includes, for each reconfigured terminal 251, the number of current pickup bills 252 (i.e., inbound bills of lading) and current delivery bills 253 (i.e., outbound bills of lading). The new linehaul schedule 254 for each reconfigured terminal 251 may be determined based upon the total weight of every destination for the reconfigured terminal 251, and determining the total weight of each matrix path (522 FIG. 5) for the reconfigured terminal 251 based upon the terminal's freight matrix (FIG. 5). The total linehaul lane weight (i.e., a summation of the lane weights, see 530 FIG. 5) may be divided by a utilization limit per truck (34000 pounds in this embodiment, although any other suitable average may be utilized in other embodiments). Put another way, this may include dividing a terminal total weight for each specific load to a destination point by a specified weight. Thus, any weight above the utilization limit would require another truck per lane. The new pickup cost 255 per reconfigured terminal 251 is based upon the mileage involved multiplied by the capacity of the trailer of the truck, and multiplied by the percentage of weight. The new delivery cost 256 of the reconfigured terminal 251 may also be provided. The new linehaul cost 257 for each reconfigured terminal 251 may be determined based upon the new linehaul schedule 254 multiplied by the total distance for the new linehaul schedule multiplied by the linehaul rate of $1.50 per mile in this embodiment (any suitable rate may be utilized in other embodiments). The new dock cost 258 for each reconfigured terminal 251 may be determined based upon the number of hours needed to move all the bills (for all the inbound bills and outbound bills) multiplied by a rate (a $25 hourly rate in this non-limiting example). The new total cost 259 for each reconfigured terminal 251 may be determined by summing the new pickup cost 255, the new delivery cost 256, the new linehaul cost 257, and the new dock cost 258.

Continuing with the table depicting loaded design comparisons view 226 from FIGS. 2B1-2, the zip code current dock cost 261 may be determined based upon the number of hours needed to move all the bills (for all the inbound bills and outbound bills) for the current terminal 229 with respect to the zip code 228 multiplied by a rate (a $25 hourly rate in this non-limiting example). The zip code current total cost 262 for the current terminal 229 with respect to the zip code 228 may be determined by summing the zip code current pickup cost 239, the zip code current delivery cost 240, the zip code current linehaul cost 241, and the zip code current dock cost 261.

A new terminal 263 may be used to determine updated values with respect to several of the foregoing values in the loaded design comparisons view 226. The changed/optimized value 264 field, depicts a dot once corresponding values new terminal values (266-273) have been determined based upon the new terminal 263. The changed/optimized value 264 field is blank in FIGS. 2B1-2 as this determination has not yet been made, although any suitable type of indicator and/or text may be utilized in other embodiments.

The zip code new miles 265 may be based upon the distance between the new terminal 263 and the zip code 228 (e.g., the center of the zip code 228 in this example). The zip code new pickup miles 266 may be based upon the number of zip code outbound bills 231 multiplied by the zip code new miles 265. The number of zip code new delivery miles 267 may be based upon the number of zip code inbound bills 233 multiplied by the zip code new miles 265. The zip code new linehaul schedule 268 may be determined by calculating each zip code's destination total weight what percentage the zip code's weight is attributable to that destination's total lane schedule weight. This percentage may then be used to determine the proportional amount for the zip code new linehaul schedule 268. The zip code new pickup cost 269 may be determined by the total pickup cost associated with the new terminal 263 with respect to the zip code 228 (i.e., the mileage involved multiplied by the capacity of the trailer of the truck, and multiplied by the percentage of weight). The zip code new delivery cost 270 of may be determined by the total delivery cost associated with the new terminal 263 with respect to the zip code 228 (i.e., the mileage involved multiplied by the capacity of the trailer of the truck, and multiplied by the percentage of weight). The zip code new linehaul cost 271 may be based upon the destination total weight of the zip code 228 used to determine a percentage of weight to a destination's total lane schedule weight, and multiplying that percentage by the total lane schedules and costs for every destination within the zip code 228. In some embodiments, the zip code new linehaul cost 271 for each new terminal 263 may be determined based upon the zip code new linehaul schedule 268 multiplied by the total distance for the linehaul schedule multiplied by the linehaul rate of $1.50 per mile in this embodiment (any suitable rate may be utilized in other embodiments). Put another way, each zip code's load to destination weight may be recalculated with that weight being divided by the total load to destination weight for the terminal. This provides a percentage of total weight by load to destination. Using the terminal's total weight for each specific load to destination point and divided those total weights by 34000 pounds (or any other suitable amount), this is rounded up to figure out the number of schedules needed. The calculated percentage of total weight by zip code is taken and multiplied that number by the total cost for the needed schedules for that load to point, thus providing each zip code's total linehaul cost 271.

A zip code new dock cost 272 may be determined based upon the number of hours needed to move all the bills (for all the inbound bills and outbound bills) for the new terminal 263 with respect to the zip code 228 multiplied by a rate (a $25 hourly rate in this non-limiting example). The zip code new total cost 273 for the new terminal 263 with respect to the zip code 228 may be determined by summing the zip code new pickup cost 269, the zip code new delivery cost 270, the zip code new linehaul cost 271, and the zip code new dock cost 272.

Turning to FIG. 2C, a zipcode change interface 276 within the site analysis tool interface is shown, continuing with the embodiment depicted in FIG. 2B. Here, a zipcode 278 has been selected, and associated terminals 280, which may include suitable replacement terminals, are displayed. For example, a user may select terminal LVE as a new terminal to service zip code 43517 instead of the current terminal. Although zip codes are used in this embodiment, any other type of geographical unit (city, county, and the like) may be utilized in other embodiments.

Turning to FIGS. 2D1-2D2, an updated site analysis tool optimization interface 282 is depicted. Here, monthly savings 284 and annual savings 286 are determined based upon a change between the new terminal 263 values, as compared to the current terminal 229 value. Given the number of factors that go into the current total cost 224 and new total cost 259 determinations, the monthly savings 284 (for example) may not be determined simply by multiplying, by the number of days in a month (such as 30), the difference between the daily current total cost 224 and daily new total cost 259 (in the daily design view option 212). This change in configuration is indicated by the dot indicator in the changed/optimized value 264 (CHG) field representing a cost advantage determined for each zip code 228, and may be considered the recalculating of a load to destination weight for a zip code.

Turning to FIG. 3, an overall cost report analysis interface 300 is depicted. An email address 301 or other suitable form of communication (phone number, social media username, and the like) may be provided to receive some or all of the overall cost analysis. A current daily totals 320 table, which may be equivalent to current site costing view 215 FIG. 2D1, provides current terminals 302 (216 FIG. 2D1), current daily pickup bills 304 (217 FIG. 2D1), current daily delivery bills 306 (218 FIG. 2D1), current daily linehaul schedule 308 (219 FIG. 2D1), current daily pickup cost 310 (220 FIG. 2D1), current daily delivery cost 312 (221 FIG. 2D1), current daily linehaul cost 314 (222 FIG. 2D1), current daily dock cost 316 (223 FIG. 2D1), and current daily total cost 318 (224 FIG. 2D1). Totals 319 may also be provided for each field, as well as tables 322, 324, and 326.

A new daily totals 322 table, which may be equivalent to new site costing view 250 FIG. 2D2, provides reconfigured terminals 328 (251 FIG. 2D2), new daily pickup bills 330 (252 FIG. 2D2), new daily delivery bills 332 (253 FIG. 2D2), new daily linehaul schedule 334 (254 FIG. 2D2), new daily pickup cost 336 (255 FIG. 2D2), new daily delivery cost 338 (256 FIG. 2D2), new daily linehaul cost 340 (257 FIG. 2D2), new daily dock cost 342 (258 FIG. 2D2), and new daily total cost 344 (259 FIG. 2D2). A monthly breakdown of current monthly totals 324 may be provided, which may correspond to a monthly design view option in 212 FIG. 2D1. A monthly breakdown of new site monthly totals 326 may also be provided.

Based upon this, pickup cost changes show an overall monthly savings of $57,704.36 based upon subtracting the total PCost 310 in the new site monthly totals 326 from the current monthly total 324 (and annually a savings of $692,452.29). Delivery cost changes show an overall monthly savings of $45,326.13 based upon subtracting the total DCost 312 in the new site monthly totals 326 from the current monthly total 324 (and annually a savings of $543,913.61). Linehaul cost changes show an overall monthly loss of $16,500.00 based upon subtracting the total LHCost 314 in the new site monthly totals 326 from the current monthly total 324 (and annually a loss of $198,000.00). Dock cost changes show an overall monthly savings of $11,288.89 based upon subtracting the total DCost 316 in the new site monthly totals 326 from the current monthly total 324 (and annually a savings of $135,466.72). The new daily pickup bills 330 for the new terminal NW1 looks reasonable at 643 bills, whereas the new daily delivery bills 332 looks light at 478 bills, by way of non-limiting example. Thus, this may provide a 43% inbound/57% outbound terminal bill breakdown. Overall, the proposed changes provide a monthly savings of $97,819.39 (see 284 FIG. 2D1), and annual savings of $1,173,832.62 (see 286 FIG. 2D1).

Turning to FIG. 4A, a zip-code based terminal service area interface 400 is depicted. Zip codes 402, represented by the smallest parcels, are grouped within terminal regions 404 (A, B, C, D, E, and the like, by way of non-limiting example) bounded by terminal region boundaries 408. This may correspond, for example, to the zip codes 228 and their correspondence to the current terminals 229 in FIG. 2B1 depicting the loaded design comparisons view. City names 406 such as Louisville are also represented.

Continuing with the zip-code based terminal service area interface depicted in FIG. 4A, an inbound/outbound interface 410 as part of the zip-code based terminal service area interface is depicted in FIG. 4B. Here, terminal DAN has been selected. An inbound/outbound interface 410 may provide an outbound bills/weight table 412 with fields for outbound originating terminals (such as the DAN terminal in this example) 414, outbound destination terminals 416, outbound number of bills 418, and outbound weight from the bills 420. An inbound bills/weight table 422 may provide inbound originating terminals 424, inbound destination terminals 426 (such as the DAN terminal in this example), inbound number of bills 428, and inbound weight from the bills 430.

Turning to FIG. 5, a freight matrix interface 500 is depicted. A site ID 502 may be provided, along with a selected terminal 504, which is BUF in this non-limiting example. In some embodiments, this is input selecting an adjustable load plan for the current terminal. The BUF terminal has total bills 506 for the terminal totaling 5,255 and a total weight 508 for the terminal of 5189229 associated with the BUF terminal corresponding to the total bills 506. A freight matrix 510 may include an originating terminal 512 (here the BUF terminal), destination terminal(s) 514, and intermediate terminal(s) 516 (LOAD 2). The freight matrix 510 may also include the number of schedule bills 518 and associated schedule weight 520 for the schedule bills 518, as it relates to the matrix path 522. For example, in the third row of the freight matrix 510, there are 93 schedule bills (518) having a combined weight of 141,133 pounds, with an originating terminal 512 (BUF), and a destination terminal 514 (ALB), making the intermediate terminal 516 also be ALB since none is specified. In this embodiment, selecting a plus sign can provide an option to add another terminal to the matrix path 522, and selecting a terminal can provide options to delete or change the selected terminal.

A schedule summary table 524 may provide, for intermediate terminal 526 (LOAD 2), a number of bills per schedule 528 that may be a summation of the number of schedule bills 518 per intermediate terminal 516 in the freight matrix 510. For example, the three instances of intermediate terminal 516 having a value of NEW have values of 109, 91, and 33 for the number of schedule bills 518 in the freight matrix 510. Summed together, these give a number of schedule bills 528 as 233 in the schedule summary table 524. Similarly, the three instances of intermediate terminal 516 having a value of NEW have weight 520 values of 96,566 pounds, 143,292 pounds, and 41,354 pounds, the summation of which appears as 281,212 pounds as the schedule weight 530 in the schedule summary table 524. The schedule 532 in the schedule summary table 524 may be determined by the schedule weight 530 divided by an optimal weight such as 34,000 pounds, with any remaining portion rounded up since the remaining portion would need its own additional truck. The average weight per schedule 534 in the schedule summary table 524 may be determined by dividing the schedule (number of trucks in the schedule) into the schedule weight 530.

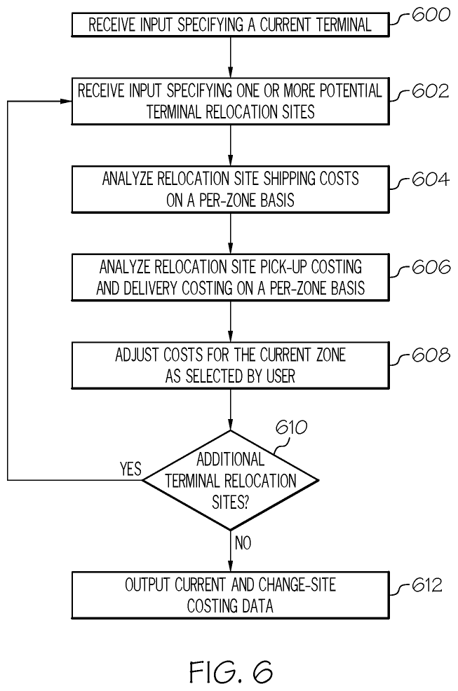

Turning now to FIG. 6, a flowchart illustrates an exemplary process providing cost analysis of a specified relocation site. At block 600, input specifying a current terminal may be received. An embodiment of this is shown in 108 FIG. 1, in which one or more terminals are selected. At block 602, input specifying one or more potential terminal relocation sites may be received. An embodiment of this is shown in 112-124 FIG. 1, in which a new terminal is added to a new location. At block 604, terminal relocation site shipping costs may be analyzed on a per-zone basis. An embodiment of this is shown in 257 FIG. 2D2, in which updated shipping costs are provided for each terminal's respective zone that may include a plurality of zip codes. At block 606, relocation site pickup costing and delivery costing may be analyzed on a per-zone basis. An embodiment of this is shown in 255, 256 FIG. 2D2, in which relocation site pickup costing and delivery costing are provided for each terminal's respective zone. At block 608, costs for the current zone may be adjusted as selected by the user. An embodiment of this is shown in the associated terminals 280 FIG. 2C selection option relating to a particular zip code. At decision block 610, a determination is made as to whether there are additional terminal relocation sites to be considered. If so, then the flowchart returns to block 602. Otherwise if not, then at block 612 current and change-site costing data may be output, such as in FIG. 3.

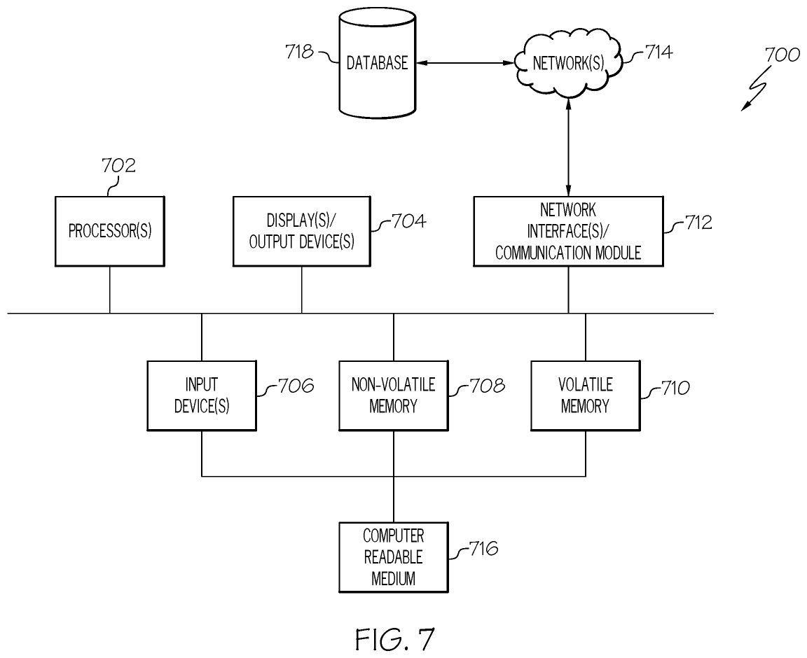

Turning now to FIG. 7, a block diagram illustrates an exemplary computing device 700, through which embodiments of the disclosure can be implemented. The computing device 700 described herein is but one example of a suitable computing device and does not suggest any limitation on the scope of any embodiments presented. Nothing illustrated or described with respect to the computing device 700 should be interpreted as being required or as creating any type of dependency with respect to any element or plurality of elements. In various embodiments, a computing device 700 may include, but need not be limited to, a desktop, laptop, server, client, tablet, smartphone, or any other type of device that can compress data. In an embodiment, the computing device 700 includes at least one processor 702 and memory (non-volatile memory 708 and/or volatile memory 710). The computing device 700 can include one or more displays and/or output devices 704 such as monitors, speakers, headphones, projectors, wearable-displays, holographic displays, and/or printers, for example.

The computing device 700 may further include one or more input devices 706 which can include, by way of example, any type of mouse, keyboard, disk/media drive, memory stick/thumb-drive, memory card, pen, touch-input device, biometric scanner, voice/auditory input device, motion-detector, camera, scale, and the like. Input devices 706 may further include cameras (with or without audio recording), such as digital and/or analog cameras, still cameras, video cameras, thermal imaging cameras, infrared cameras, cameras with a charge-couple display, night-vision cameras, three-dimensional cameras, webcams, audio recorders, and the like.

The computing device 700 typically includes non-volatile memory 708 (ROM, flash memory, etc.), volatile memory 710 (RAM, etc.), or a combination thereof. A network interface 712 can facilitate communications over a network 714 via wires, via a wide area network, via a local area network, via a personal area network, via a cellular network, via a satellite network, etc. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM. Network interface 712 can be communicatively coupled to any device capable of transmitting and/or receiving data via one or more network(s) 714. Accordingly, the network interface hardware 712 can include a communication transceiver for sending and/or receiving any wired or wireless communication. For example, the network interface hardware 712 may include an antenna, a modem, LAN port, Wi-Fi card, WiMax card, mobile communications hardware, near-field communication hardware, satellite communication hardware and/or any wired or wireless hardware for communicating with other networks and/or devices. One or more databases 718 may be accessed via the network(s) to remotely access data and store data, such as terminal service areas, site design management databases, freight matrices, and the like.

A computer-readable medium 716 may comprise a plurality of computer readable mediums, each of which may be either a computer readable storage medium or a computer readable signal medium. A computer readable storage medium may reside, for example, within an input device 706, non-volatile memory 708, volatile memory 710, or any combination thereof. A computer readable storage medium can include tangible media that is able to store instructions associated with, or used by, a device or system. A computer readable storage medium includes, by way of example: RAM, ROM, cache, fiber optics, EPROM/Flash memory, CD/DVD/BD-ROM, hard disk drives, solid-state storage, optical or magnetic storage devices, diskettes, electrical connections having a wire, or any combination thereof. A computer readable storage medium may also include, for example, a system or device that is of a magnetic, optical, semiconductor, or electronic type. Computer readable storage media and computer readable signal media are mutually exclusive.

A computer readable signal medium can include any type of computer readable medium that is not a computer readable storage medium and may include, for example, propagated signals taking any number of forms such as optical, electromagnetic, or a combination thereof. A computer readable signal medium may include propagated data signals containing computer readable code, for example, within a carrier wave. Computer readable storage media and computer readable signal media are mutually exclusive.

The computing device 700 may include one or more network interfaces 712 to facilitate communication with one or more remote devices, which may include, for example, client and/or server devices. A network interface 712 may also be described as a communications module, as these terms may be used interchangeably.

It should now be understood that embodiments of the present disclosure are directed to terminal relocation analysis. The addition of a new terminal can produce a change in cost that can be analyzed in a variety of ways, such as the change in shipping cost on a per-zip-code basis. This may be accomplished by going through every zip code and mathematically figure out the best pickup and delivery costing advantage of moving that specific zip code. Costs associated with a distribution center may include pickup charges, delivery charges, linehaul charges, and dock changes may be considered as a quick and easy way to evaluate new potential terminal locations added to a shipper's network and what the overall costing impact will be. This analysis can then be used to effect a very real world change in terms of terminal placement, which may affect the efficiency of the flow of goods.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method of terminal site optimization comprising:
receiving input specifying a current terminal;
receiving input specifying one or more potential terminal relocation sites;
analyzing costs of a relocation site based upon:
shipping costs on a per-service area basis;
pickup costing and delivery costing on a per-service area basis; and
adjusted costs for the current terminal; and
outputting current and change-site costing data.

2. The method of claim 1 wherein the pickup costing is determined by:
(i) dividing a total weight picked up in a specified zip code by an average pickup unit weight;
(ii) multiplying a result of (i) by mileage to the specified zip code;
(iii) multiplying a result of (ii) by an average driving speed; and
(iv) multiplying a result of (iii) by driver cost per hour.

3. The method of claim 1 wherein the delivery costing is determined by:
(i) dividing a total weight delivered to a specific zip code by an average pickup unit weight;
(ii) multiplying a result of (i) by mileage to the specified zip code;
(iii) multiplied a result of (ii) by an average driving speed; and
(iv) multiplying a result of (iii) by driver cost per hour.

4. The method of claim 1 wherein relocation sites are based upon zip codes.

5. The method of claim 1 further comprising:
receiving input selecting an adjustable load plan for the current terminal;
recalculating a load to destination weight for a zip code; and
dividing the weight by a total load to destination weight for a terminal to determine a percentage of total weight by load to destination.

6. The method of claim 5 further comprising:
dividing a terminal total weight for each specific load to a destination point by a specified weight; and
determining a total linehaul cost per zip code by multiplying a calculated percentage of total weight by zip code by a total cost for schedules for that load to a destination point.

7. The method of claim 1 further comprising modifying current service areas based upon zip code alignment changes with respect to zip codes within each of a plurality of service areas.

8. A terminal site optimization system comprising:
memory;
a processor coupled to the memory;
a user interface module configured to:
receive input specifying a current terminal;
receive input specifying one or more potential terminal relocation sites; and
output current and change-site costing data; and
a cost assessment module configured to analyze costs of a relocation site based upon:
shipping costs on a per-service area basis;
pickup costing and delivery costing on a per-service area basis; and
adjusted costs for the current terminal as selected by the user.

9. The system of claim 8 wherein the cost assessment module is further configured to:
(i) divide a total weight picked up in a specified zip code by an average pickup unit weight;
(ii) multiply a result of (i) by mileage to the specified zip code;
(iii) multiply a result of (ii) by an average driving speed; and
(iv) multiply a result of (iii) by driver cost per hour.

10. The system of claim 8 wherein the cost assessment module is further configured to:
(i) divide a total weight delivered to a specified zip code by an average pickup unit weight;
(ii) multiply a result of (i) by mileage to the specified zip code;
(iii) multiply a result of (ii) by an average driving speed; and
(iv) multiply a result of (iii) by driver cost per hour.

11. The system of claim 8 wherein relocation sites are based upon zip codes.

12. The system of claim 8 wherein:
the user interface module is further configured to receive input selecting an adjustable load plan for the current terminal; and
the cost assessment module is further configured to:
recalculate a load to destination weight for a zip code; and
divide the weight by a total load to destination weight for a terminal to determine a percentage of total weight by load to destination.

13. The system of claim 12 wherein the cost assessment module is further configured to:
divide a terminal total weight for each specific load to a destination point by a specified weight; and
determine a total linehaul cost per zip code by multiplying a calculated percentage of total weight by zip code by a total cost for schedules for that load to a destination point.

14. The system of claim 8 wherein the cost assessment module is further configured to modify current service areas based upon zip code alignment changes with respect to zip codes within each of a plurality of service areas.

15. A non-transitory computer readable medium embodying terminal site optimization computer-executable instructions, that when executed by a processor, cause the processor to execute operations comprising:
receiving input specifying a current terminal;
receiving input specifying one or more potential terminal relocation sites;
analyzing costs of a relocation site based upon:
shipping costs on a per-service area basis;
pickup costing and delivery costing on a per-service area basis; and
adjusted costs for the current terminal; and
outputting current and change-site costing data.

16. The medium of claim 15 further comprising additional computer-executable instructions that cause the processor to execute operations comprising:
(i) dividing a total weight picked up in a specified zip code by an average pickup unit weight;
(ii) multiplying a result of (i) by mileage to the specified zip code;
(iii) multiplying a result of (ii) by an average driving speed; and
(iv) multiplying a result of (iii) by driver cost per hour.

17. The medium of claim 15 further comprising additional computer-executable instructions that cause the processor to execute operations comprising:
(i) dividing a total weight delivered to a specific zip code by an average pickup unit weight;
(ii) multiplying a result of (i) by mileage to the specified zip code;
(iii) multiplied a result of (ii) by an average driving speed; and
(iv) multiplying a result of (iii) by driver cost per hour.

18. The medium of claim 15 wherein relocation sites are based upon zip codes.

19. The medium of claim 15 further comprising additional computer-executable instructions that cause the processor to execute operations comprising:
receiving input selecting an adjustable load plan for the current terminal;
recalculating a load to destination weight for a zip code; and
dividing the weight by a total load to destination weight for a terminal to determine a percentage of total weight by load to destination.

20. The medium of claim 19 further comprising additional computer-executable instructions that cause the processor to execute operations comprising:
dividing a terminal total weight for each specific load to a destination point by a specified weight; and
determining a total linehaul cost per zip code by multiplying a calculated percentage of total weight by zip code by a total cost for schedules for that load to a destination point.
